(19) United States
(12) Patent Application Publication
(10) Pub. No.: US 2016/0135485 A1
(43) Pub. Date: May 19, 2016

(54) PRODUCTION OF FOOD GRADE DISTILLERS DRIED GRAINS

(71) Applicant: The South Dakota Board Of Regents, Brookings, SD (US)

(72) Inventor: Padmanaban KRISHNAN, Brookings, SD (US)

(73) Assignee: THE SOUTH DAKOTA BOARD OF REGENTS, Brookings, SD (US)

(21) Appl. No.: 14/845,085

(22) Filed: Sep. 3, 2015

Related U.S. Application Data
(60) Provisional application No. 62/045,057, filed on Sep. 3, 2014.

(51) Int. Cl. A23K 1/06

(52) U.S. Cl. CPC A23L 1/0152; A23L 1/1041; A23K 1/06; A23L 1/2112; A23L 1/2005; A23L 1/1025; A23L 1/27; A23V 2002/00

(57) ABSTRACT

The invention provides methods and processes that can be used to process industrial FDDG to food grade FDDG (FDDG). The FDDG product is substantially reduced of color, is high in protein and fiber, is odor-neutral, and is safe for human consumption. The present invention further provides processing schemes to minimize FDDG variability, and to insure uniform food functionality traits. The invention also provides novel and effective applications and uses of Supercritical CO₂ extraction in the preparation of the FDDG product.

### CROSS-REFERENCE TO RELATED APPLICATIONS

This application claims benefit of Application No. 62/045,057, filed Sep. 3, 2014 in the US and which application is incorporated herein by reference. A claim of priority is made.

### BACKGROUND OF THE INVENTION

Ethanol is produced from a wide variety of plant-derived materials. The starting material or materials and the processes used to produce ethanol are determinative of the end products of the ethanol production process. Thus, both the processes for ethanol production are varied and the starting materials are varied, and these factors lead to differences in end products and by-products.

One end product of the ethanol production process is Distillers Dried Grains (DDG). While DDG from ethanol plants are varied in chemical and nutritional composition, in general, DDG are high in protein. Despite the lack of uniformity in chemical nutritional composition, DDG is frequently incorporated into livestock feed. While this is lack of uniformity in nutritional composition is acceptable for feed applications for livestock, the wide variation in DDG quality and nutrient content is not acceptable in the food market for humans and companion animals. The chemical and nutritional composition of DDG also has an effect on food functionality, such as how the ingredient actually assists in improving food quality traits. These traits include, but are not limited to, texture, mouth-feel, and flow-ability.

### SUMMARY OF THE INVENTION

The inventive methods and processes can be used to process industrial DDG to food grade DDG while recovering DDG that is higher protein content due to removal of residual corn oil not removed in the ethanol plant processes.

The present invention can be processing schemes to minimize DDG variability, and to insure uniform food functionality traits.

The present invention can be the processing treatments and instrumentation employed in the production of food grade distillers grains from industrial DDG sources. Provided are processes for preparing a food grade distillers dried grain (FDDG) product, comprising, a) steeping an amount of distillers dried grains (DDG) or distillers dried grains with solubles (DDGs) with an amount of a food grade first solvent to create a slurry, wherein the weight to volume ratio of solids to solvent is 1:1, b) stirring the slurry continuously for an amount of time, c) removing the first solvent from the solids, d) adding second amount of the first solvent to the solids create a slurry, wherein the weight to volume ratio of solids to solvent is 1:1, and stirring the slurry continuously for an amount of time, e) removing the first solvent from the solids, f) repeating steps d) and e) one or more times, g) washing the solids with an amount of a food grade second solvent for an amount of time, h) removing the second solvent from the solids, i) repeating steps g) and h) one or more times; i) drying the solids to remove the second solvent, and i) milling the washed, dried solids to a uniform size, wherein the result is a food grade distillers dried grain (FDDG) product.

In certain embodiments of the processes and methods of the invention, the first solvent is selected based on polarity of the solvent, solubility of target pigments, or solubility of flavor compounds to remove, or a combination thereof. In other embodiments of the processes and methods of the invention, the first solvent is ethanol or Supercritical CO₂. In still other embodiments of the processes and methods of the invention, the second solvent is water.

In some embodiments of the processes and methods of the invention, the drying is freeze drying or lyophilizing. In other embodiments of the processes and methods of the invention the FDDG product is sterilized by heat treatment, pressure treatment, or a combination thereof. In some embodiments, the FDDG is sterilized after milling by heating the FDDG product to about 120 C for 5 to 30 minutes, with steam injections and agitation. In certain embodiments of the processes and methods of the invention, the milling is ultra-grinding, and the FDDG product has a particle size of about <1.0 mm. In an embodiment of the processes and methods of the invention, after step d) of the process, the solids are optionally extracted using Supercritical CO₂ extraction.

According to certain embodiments of the processes and methods of the invention, at least a portion of the first solvent, the second solvent or both solvents are recovered. In some embodiments contemplated by the processes and methods of the invention, pigments and oil are extracted from the recovered solvents.

In some embodiments of the processes and methods of the invention, the DDG or DDGs is derived from any plant material, including but not limited to corn. In other embodiments of the processes and methods of the invention, the process is completed in one or more vessels.

In an embodiment of the processes and methods of the invention, the processes and methods produce the food grade distillers dried grain product. In other embodiments, the food grade distillers dried grain product is a product of the processes and methods of the invention.

The invention also provides a food grade distillers dried grain product, comprising a solvent-treated plant-derived material having reduced pigmentation as compared to the plant derived material not treated with solvents, wherein the product has uniform particle size, is odor-neutral, and is at least 25% protein, at least 30% dietary fiber and less than 15% fat. In other embodiments, the food grade distillers dried grain product contains a protein content of at least 30% and a dietary fiber content of at least 35%, and less than 10% fat. In certain embodiments of the food grade distillers dried grain product of the invention, the particle size is <0.6 mm.

### BRIEF DESCRIPTION OF THE DRAWINGS

FIG. 1 shows color and particle size distinctions of food grade DDG (FDDG) at different stages of processing. A) food grade DDG (FDDG) subjected to supercritical CO₂ processing; B) food grade DDG (FDDG) as processed using South Dakota State University protocol (see Example 1); C) unprocessed, dried DDG as received from ethanol plant.

FIG. 2 shows color and particle size distinctions of food grade DDG (FDDG) at different stages of processing. A) food grade DDG (FDDG), as processed using ethanol and water washings, followed by drying and grinding; B) unprocessed, dried DDG as received from ethanol plant.

FIG. 3 shows food (cookies) prepared with food grade DDG (FDDG). FDDG was incorporated into the cookie dough prior to baking.

FIG. 4 shows products made with Garbanzo flour (Chickpea) co-extruded with 5% FDDG. A) gram flour extrusion, 115° C., 80 rpm, 16% Moisture Content (MC); B) 5% FDDG, 17% Moisture Content (MC), 120° C., 85 rpm; C) 5% FDDG, 17% Moisture Content (MC), 120° C., 70 rpm; D) 5% FDDG, 17% Moisture Content (MC), 120° C., 80 rpm; E) Extrudate.

FIG. 5 shows food-grade DDG-produced via ethanol washing as compared to Carbon Dioxide Processed DDG, and Raw DDGs. A) Raw DDGs; B) Ethanol Processed FDDG, and C) SCO₂-Ethanol processed FDDG.

FIG. 6 shows differences in color of various DDGs and FDDG. A) Raw DDGs; (B) Raw DDGs Milled and CO₂ processed @ 7200 psi, 50° C.; (C) Raw DDGs Milled and CO₂ processed @ 10,000, 50° C.; (D) FDDG Processed at SDSU, no CO₂ Treatment; (E) FDDG Processed at SDSU @ 10,000 psi, 50° C.; (F) FDDG Processed at SDSU 7200 psi 50° C. Particle sizes are slightly different for DDGS and FDDG but visual differences in terms of appearance are observable.

FIG. 7 is a sample diagrammatic representation of a super critical fluid extraction apparatus, with CO₂ as the solvent. The apparatus components are: (A) Liquid CO₂; (B) Modifier pump; (C) Solvent pre-heating coil; (D) Extraction Vessel with sample; (E) Restrictor; (F) Collection vessel; (G) Temperature controlled oven; (H) CO₂ pump; (I) On-off valve; (J) On-off valve.

FIG. 8 is another sample diagrammatic representation of a super critical fluid extraction apparatus, with CO₂ as the solvent. The apparatus components are as follows: (A) CO₂; (B) Pump; (C) Coolant; (D) Extraction cell; (E) BPR; (F) Vial; (G) BPR controller; (H) Oven; (I) Pump; (J) Modifier.

FIG. 9 shows C-Cell images of steamed bread with different percents of FDDG as follows: A) 0% DDG; B) 10% DDG; C) 15% DDG; D) 20% DDG; E) 25% DDG.

FIG. 10 shows a typical Mixolab curve.

### DETAILED DESCRIPTION OF THE INVENTION

### Definitions

As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation.

The term “and/or” means any one of the items, any combination of the items, or all of the items with which this term is associated. The phrase “one or more” is readily understood by one of skill in the art, particularly when read in context of its usage. For example, one or more substituents on a phenyl ring refer to one to five, or one to four, for example if the phenyl ring is disubstituted.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values, e.g., weight percents, proximate to the recited range that are equivalent in terms of the functionality of the individual ingredient, the composition, or the embodiment.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

An “effective amount” refers to an amount effective to bring about a recited effect.

A “fluid” refers to a substance that has no fixed shape and readily yields to external pressure. A fluid is a composition that can flow in response to gravity or another external force. A fluid is typically a gas or a liquid.

As used herein, “distillers dried grain” or “DDG” refers to a plant-derived material. DDG may be a by-product of ethanol production. DDG may also be referred to as “Spent Grain”. DDG is the residue that results from removal of fermentable carbohydrates in the form of ethanol. It is the sum total of what was the starting material (corn or other plant-derived material) in ethanol production, minus the fermentable sugars and starch.

As used herein, “distillers dried grain with solubles” or “DDGs” refers to a plant-derived material. DDGs may be a by-product of ethanol production, containing DDG and liquid solubles. DDG can be the particulate material in the ethanol production process that was sieved out with mesh, which allowed for it to be separated from the solubles. DDG and the solubles are retained separated. The solubles are then concentrated and added back to the DDG. The DDG/solubles mixture is then dried down to yield DDGs. For all practical purposes FDDG is DDGs that has been washed repeated, dried, ground, and sterilized.

As used herein, “food grade distillers dried grain” or “FDDG” refers to a plant-derived material that has been treated with solvents to reduce pigmentation as compared to the same plant derived material not treated with solvents, wherein the material is at least 35% protein, at least 30% dietary fiber and less than 15% fat. FDDG may be a plant-derived material that is made by processing DDGs or DDG from by-products of ethanol production. In addition, “food grade distillers dried grain product” may also refer to a plant-derived material by-product of ethanol production that has been washed and treated with solvents extensively to reduce pigmentation and odor, dried, ground to a fine particle size, and sterilized. FDDG is safe for human consumption and has a high protein and fiber content.

As used herein, “steeping” refers to soaking in a liquid to soften, cleanse or extract some constituent. Steeping may refer to soaking a plant-derived material, including but not limited to DDG or DDGs, in one or more solvents for a period of time.

Particulate materials of plant origin, particularly those containing cell wall materials, have different rates of solvent absorption. Those with cell wall materials will hydrate at slower rates. Steeping is used in many industries to allow solvent penetration of cell wall materials. As a non-limiting example, the brewing industry uses steeping for barley, so that the grains imbibe water and seed begins to germinate. Germination is critical to flavor development of beer. In another non-limiting example, steeping is used in corn processing as a method to provide sufficient time for the solvents or washing media to penetrate all of the sample materials.

As used herein, “slurry” refers to a mixture of solids and liquids, or a semi-liquid mixture. In some cases, slurry refers to a suspension of particles in liquid.

As used herein, “solvent” refers to a substance that dissolves a solute. A solvent can be a liquid, solid or a gas. The solvents used in the methods and processes herein may be selected based on polarity of the solvent, solubility of target pigments to remove, or flavor compounds to remove, or a combination thereof.

As used herein, “pigment” refers to a material that changes the color of reflected or transmitted light as a result of wavelength-selective absorption. Pigment also refers to a matter or material or substance that gives color to a material or materials. For example, the yellow color of certain corn is from pigments called carotenoids and xanthophylls.

As used herein, “stirring” refers to physical continuous agitation. Stirring may be accomplished by any means to create physical continuous agitation, including but not limited to, mixers, such as propeller mixers or any other means for creating physical continuous agitation.

As used herein, “milling” refers to a process of breaking down, separating, sizing, grinding, granulating, or pressing a substance. Milling may refer to the reduction of particle size of attrition between high speed metallic pins, including but not limited to stainless steel pins.

As used herein, “washing” refers to soaking and decanting of liquids while retaining solids. Washing may refer to repeated soaking and decanting of liquids while retaining solids.

As used herein, “sterilizing” refers to heat treatment, pressure treatment, or a combination thereof. Heat treatment may comprise adding heat to 120° C. for approximately 5 to 30 minutes, with steam injections and agitation.

As used herein, “drying” refers to a mass transfer process consisting of the removal of a solvent by evaporation from a solid, semi-solid or liquid. Drying may include freeze drying, vacuum drying, gas stream drying, drum drying, or any other method of drying. Drying may also refer to the removal of water under a slow of filtered air.

As used herein, “ultra-grinding” refers to an abrasive machining process that may use grinding wheels or other cutting tools, rotors, knives, mortars, discs, impact or friction, or a combination thereof, to create ultra-fine particles. Certain sieves, such as Tyler sieves, have different size openings. White wheat flour may have a particle size of 200, which means that all of it will pass through a sieve with fine openings. The larger the sieve number, the smaller the opening. The smaller the sieve number, the larger is the opening. In certain non-limiting embodiments, corn meal may be retained on a Number 20 sieve.

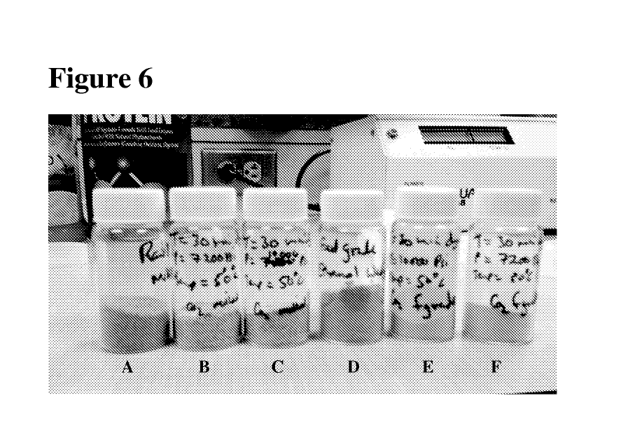

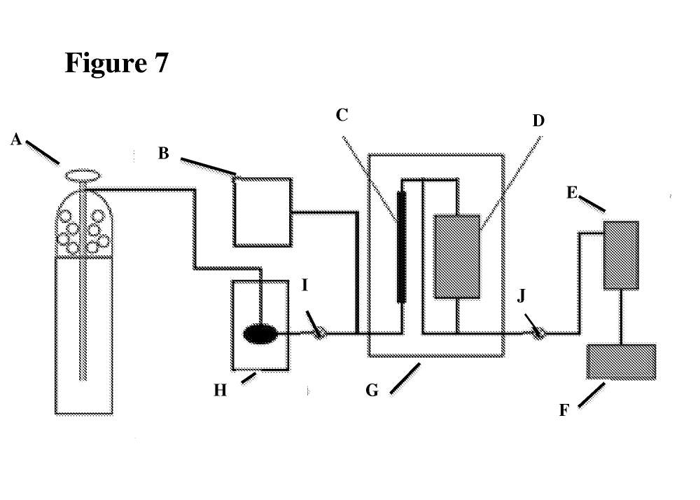

As used herein, “supercritical fluid extraction” or “SFE” is the process of separating one component (the extractant) from another (the matrix) using supercritical fluids as the extracting solvent. Extraction is usually from a solid matrix, but can also be from liquids. See FIGS. 6A and 6B.

As used herein, “supercritical CO₂ extraction” refers to processes of extracting a compound or compounds from a substance, using supercritical carbon dioxide. Supercritical carbon dioxide is a fluid state of carbon dioxide, where it is held at or above its critical temperature and critical pressure. Supercritical CO₂ is used as a solvent in chemical extractions because it has low toxicity and low environmental impact. Supercritical CO₂ extraction is a process that can be down at a relatively low temperature.

As used herein, “recovering” refers to regaining a desired substance from a complex mixture. Recovering can refer to procuring a solvent from an extraction method.

As used herein, “recycling” refers to the activity or process of reusing useful materials or substances found in waster.

As used herein, “plant-derived” refers to materials, substances, compounds and the like that are made from plants or plant material. Plants are multicellular eukaryotes of the kingdom Plantae. In certain embodiments of the inventions provided here, wheat, sorghum, rice, barley and other grains can be used to make FDDG. See, for example, San Buenaventura, et al., Cereal Chemistry, 64 (2): 135-6 (1987); Mussato, et al., J. Cereal Sci, 43: 1-14 (2006); Dreese, P. C. and R. C. Hoseney, Cereal Chem. 59(2): 89-91 (1982); Dong et al., Cereal Chem 64(4): 327-332 (1987).

Distillers dried grains (DDGs) from corn is the main by-product of corn alcohol industry (Belyea, 2004). The output of DDGs is very high every year. In 2014, approximately 39 million metric tonnes of DDGs were produced in the U.S. Most of the DDGs is used as animal feed and some is discarded as waste. When DDGs is discarded, significant resources are wasted. (Cromwell, 1993; Lumpkins, 2004; Stein, 2009).

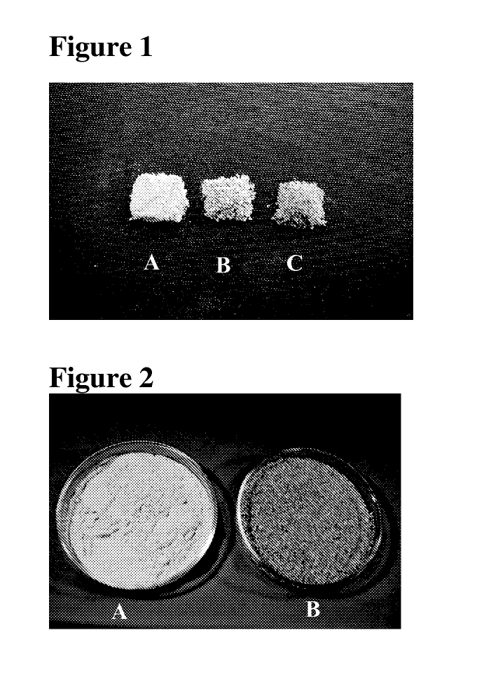

The present invention provides methods and processes for the conversion of DDGs into a replicable and usable food grade product (FIG. 1) that can be used to bring new food products and formulations to market (FIG. 2). The processes and methods provided herein can produce a high quality material for subsequent use by food companies and incorporation into food products. In certain embodiments, the process begins with a starting material that is a co-product of ethanol production, DDGs. DDGs is currently underutilized as an animal feed product, a component of animal feed, or simply discarded as waste. In other embodiments, DDG is the starting material. In some embodiments of the methods, processes and products provided herein, DDGs can be derived from any plant material, including, but not limited to, the plant based material used in the production of ethanol. In certain embodiments, DDGs is derived from corn. In other embodiments, DDG is derived from corn. Any of the processes and methods of the invention may also use DDGs as a starting material.

In addition, the methods and processes provided herein provide avenues for recycling and reusing the solvents used in the processes and methods. As a non-limiting example, the solvent used to remove pigments may be CO₂ produced from ethanol production. CO₂ a normal by-product of ethanol production. It is frequently considered waste and is released into the environment. Using the methods and processes provided herein, two ethanol production by-products can be diverted from waste and used in the production of nutritionally valuable ingredients for food. In some embodiments, during the methods and processes of the invention, pigments, odors and oils are removed from the DDGs with solvents. The pigments include, but are not limited to, carotenoids and xanthophylls. In certain embodiments of the methods and compositions of the invention, the retention of the solvents containing the pigments and oils occurs, and therefore, the solvents, oils and pigments are captured. The solvents may be reused, recycled or repurposed. The pigments and oils may be separated from the solvents. The pigments may then be used for a variety of products, including but not limited to nutraceuticals, supplements, vitamins, or for any other desired product or use of pigments. The oils may be used for production of biodiesel or industrial oils or they may be refined further just as vegetable oils are refined (hydrogenation, cold filtration, deodorization, winterization), or for any desired use. The solvents can be reused for producing further amounts of FDDG or for any other desired use of the solvent.

Thus, in certain embodiments, the present methods and processes use ethanol production waste or by-products (DDGs and CO₂) to make a variety of valuable commodities, including but not limited to, FDDG, CO₂, nutraceuticals, oils and supplements. The products and processes of the invention provide increased revenues for the ethanol production industry, as well as eliminate losses from the cost of discarding DDGs. In addition, these products and processes benefit the environment by decreasing the greenhouse gas issues associated with the release of CO₂ and diverting by-products products away from the waste stream. Recycling may reduce the effluent that may otherwise be released into the atmosphere. Heat generated elsewhere in an ethanol processing facility may efficiently be used to recycle solvents, which than can be distilled to be reused. Due to the high cost of solvents, recycling and reusing solvents is yet another beneficial impact of the processes and methods of the invention In addition, the FDDG of the invention, and the FDDG products of the processes of the invention provide safe, valuable ingredients that assist in enhancing the nutritional composition of food and improving food quality traits, such as texture, flavor, mouth-feel, flowability, and the like. The FDDG of the invention, and the FDDG products of the processes of the invention, have minimal variability, due to the processes and methods of the invention, which insure uniform food functionality traits. The development of new method of producing food grade DDG (FDDG) has significant social and economic benefits.

The FDDG of the invention, as well as the FDDG produced by the processes and methods of the invention, have physical traits in the fiber moiety that make FDDG compatible for use with wheat flour without being obtrusive and without damaging food structure of finished baked products. In contrast, other plant-derived materials or plant fibers not treated by the processes and methods of the invention, or not treated whatsoever, exert enormous undesirable influence in food systems and hamper desired food traits, including, but not limited to, the ability to form films, to form foams, to trap gasses to resist extensibility, to hold water, to hold fats and to provide texture.

It is known that DDG is an ideal source of dietary fiber, comprising of cellulose and, hemicellulose, and a small amount of lignin (Rose, 2010), but it is not used in foods for humans and is not generally considered safe for eating.

The methods and processes of the invention, in some embodiments, can readily produce Food Grade Distillers Dried Grain (FDDG) with at least 20% protein. In certain embodiments, the processes and methods of the invention can produce FDDG having at least 25% protein. In other embodiments, the processes and methods of the invention can produce FDDG having at least 35% protein. In other embodiments, the FDDG produced by the methods and processes of the invention has approximately 15% to approximately 50% protein.

The methods and processes of the invention, in some embodiments, can readily produce Food Grade Distillers Dried Grain (FDDG) with at least 20% fiber. In certain embodiments, the processes and methods of the invention can produce FDDG having at least 30% fiber. In other embodiments, the processes and methods of the invention can produce FDDG having at least 35% fiber. In other embodiments, the FDDG produced by the methods and processes of the invention has approximately 15% to approximately 50% fiber.

In some embodiments, the FDDG of the invention contains at least 20% protein. In certain embodiments, the FDDG of the invention contains at least 25% protein. In other embodiments, the FDDG of the invention contains at least 35% protein. In other embodiments, the FDDG of the invention has approximately 15% to approximately 50% protein.

In some embodiments, the FDDG of the invention contains at least 20% fiber. In certain embodiments, the FDDG of the invention contains at least 30% fiber. In other embodiments, the FDDG of the invention contains at least 35% fiber. In other embodiments, the FDDG of the invention has approximately 15% to approximately 50% fiber.

The FDDG produced by the methods and processes of the invention is an ingredient that has applications as a protein and fiber enrichment agent supplement. The FDDG of the invention is a material that has applications as a protein and fiber enrichment agent or supplement.

In an embodiment, FDDG has at least 20% dietary fiber (20% Total Dietary Fiber (TDF)). In another embodiment, FDDG has at least 30% dietary fiber (30% Total Dietary Fiber (TDF)). In a further embodiment, FDDG has at least 35% dietary fiber (35% Total Dietary Fiber (TDF)). In yet another embodiment, FDDG has at least 40% dietary fiber (40% Total Dietary Fiber (TDF)). Because of this high fiber content, FDDG is therefore, beneficial for human health.

Adding FDDG to flour increases the value of by-products of the ethanol process, and improves the nutritional profile of many flours, including but not limited to flours from wheat, corn, coconut, rice, soy, oat, almond, amaranth, barley, buckwheat, chickpea, millet, pumpernickel, self-rising, quinoa, rye, semolina, pumpernickel, self-rising, sorghum, spelt, tapioca, teff, all purpose, bread, and whole wheat.

FDDG is also a shelf stable product, requiring no special preservation technology. FDDG can be incorporated into many foods without difficulty. FDDG is an especially beneficial product, as it can be easily incorporated into many indigenous foods developing countries. Thus, FDDG can provide enhanced nutritional profiles to foods across the globe.

In certain embodiments, the process for converting DDGs to FDDG involves one or more washings, heat treatment and moisture removal, ultra-grinding, and supercritical CO₂ extraction. In certain embodiments, the entire process for converting DDGs to FDDG can be accomplished in one vessel. In other embodiments, the entire process for converting DDGs to FDDG can be accomplished in a single vessel or chamber that is no larger than a common household dishwashing machine.

In certain embodiments, DDGs can be subjected to one or more washings with solvents characterized by solvent polarity, solubility of pigments targeted for removal, & flavor compounds selected for removal from the DDGs, as well as general compatibility for food use applications. In other embodiments, DDGs can be subjected to at least one washing with solvents characterized by solvent polarity, solubility of pigments targeted for removal, & flavor compounds selected for removal from the DDGs, as well as general compatibility for food use applications. In still other embodiments, DDGs can be subjected to up to 50 washings with solvents characterized by solvent polarity, solubility of pigments targeted for removal, & flavor compounds selected for removal from the DDGs, as well as general compatibility for food use applications. In some embodiments, the washings of the processes and methods herein can be employed in a specific sequence. In an embodiment, the solvents that can be used in the methods and processes of the invention are food grade ethanol (100%) and distilled water.

In certain embodiments of the processes and methods of the invention, the choice of sequence of solvents is determined by the effectiveness of the pigment removal as judged by effluent color. For example, an exhaustive ethanol washing the solids with about three times the volume of solids followed by water washing with about three times the volume of solids. In other embodiments of the processes and methods of the invention, the choice of sequence of solvents is determined by the effectiveness of the flavor removal desired. In still other embodiments of the processes and methods of the invention, the choice of sequence of solvents is determined by the effectiveness of the pigment or flavor, or both pigment and flavor removal desired. In the processes and methods of the invention, harsh chemicals such as hexanes, petroleum distillates are not used, as they are not be appropriate for extraction of ingredients intended for foods.

In an embodiment of the invention, the milling is done by grinding the solids in a circular grinder, where the fine materials pass through a sieve of a selected size, and then onto a stainless steel collection pan or trough. The milling is done in a food grade mill.

The stainless steel collection pan facilities washing and sterilization to make the product food grade. In certain embodiments, the milling occurs in a pin mill, including but not a mill limited to a Restch Mill (GmbH & Co. KG, 5657 HAAN1, Germany).

In further embodiments of the invention, the solids are dried. The options for drying methods are many and include, but are not limited to, freeze drying. Drying the solids of the processes and methods of the invention give the washed, solvent-extracted DDG to low moisture content. In certain embodiments, the drying is freeze drying.

In still other embodiments of the methods and processes of the invention, the solids are sterilized to kill all microbes or pathogens, and to allow the FDDG product to remain sterile and able to be incorporated into foods for human consumption. In some embodiments of the processes and methods of the invention, a sterilizer provides batch heat sterilization of washed, solvent extracted, milled, and dried DDG solids. In other embodiments, DDG is heat sterilized in sealed containers, vessels, jars, or any container desired. In certain other embodiments, during heat sterilization, steam does not penetrate the seal of the container, but is effective in killing any microbes or pathogens present in the solids.

In the processes and methods of the invention, heat and pressure treatment can be accomplished by any known means to achieve microbiological sterility in the washed DDGs. A non-limiting example of heat treatment is heating the DDGs to about 120° C. for 15 min, performed in a stainless steel vessel equipped with agitation and steam injection attachments to increase efficiency in the process. In some embodiments of the processes and methods of the invention, after the heat treatment the DDGs may have the moisture removed by any known drying method or moisture removal method, including but not limited to freeze drying or lyophilization. In an embodiment of the invention, the washed, dried and milled DDGs solids are sterilized in appropriate containers. After sterilization, the material is FDDG.

In some embodiments of the processes and methods of the invention, dried DDGs can be subjected to ultra-grinding to a selected particle size range of about <1.0 mm, about <0.9 mm, about <0.8 mm, about <0.7 mm, about <0.6 mm, about <0.5 mm, or about <0.4 mm. In other embodiments of the processes and methods of the invention, dried DDGs can be subjected to ultra-grinding to achieve a selected particle size range of between about 1.0 mm to about 0.01 mm.

In some embodiments of the processes and methods of the invention, the DDGs solids from the ultra-grinding are optionally subjected to Supercritical CO₂ extraction (Table 3). In certain embodiments, SCO₂ extraction of the DDGs solids, after the first solvent treatments, provides an optional enhanced benefit of further color removal. In some embodiments, SCO₂ extraction of the DDGs solids is a discretionary or ancillary part of the processes and methods of the invention.

Supercritical CO₂ extraction (SCO₂ extraction) is a type of supercritical fluid extraction (SFE), and it can be accomplished by any known means, including but not limited to instruments including one or more tanks of CO₂ or fluid reservoirs for CO₂, followed by one or more syringe pumps having a pressure rating of at least 400 atm, one or more valves to control the flow of the critical fluid into a heated extraction cell, and finally an expansion nozzle for depressurizing the fluid and transferring it into collection devices. Extraction pressure, temperature and CO₂ flow rate are three important factors for SFE. The change of extraction pressure, extraction temperature, or both, can alter the CO₂ density, thereby manipulating the solvation power of CO₂. Carbon dioxide flow rate can affect mass transfer rates of extracts and thus change the extraction efficiency. SFE can be an efficient extraction process. SFE allows processing at low temperature (near the critical temperature of SF), which prevents the decomposition of thermal-sensitive products and leaves no solvent residues in the products. The SFE product is therefore safe for the food industry and human health. For these reasons, SFE-CO₂ may be an effective, safe technique to extract and prepare various products from natural sources, and according to certain embodiments of the invention, it is safe and effective for the extraction of pigments and flavorings from DDGs, DDG, or any plant-derived material and arrive at FDDG. The FDDG can then be blended into various food products, including but not limited to flours, cereals and other foods. (See FIG. 2). In some embodiments of the invention, CO₂ is pressurized to a state where it exists between a liquid and a gas, and can be between 5000 psi to 15000 psi, or between 6500 psi and 12500 psi. The CO₂ is heated to approximately 50° C., and then is used as a solvent for removing pigments from DDGs.

### EXAMPLES

### Example 1

### Food Grade DDG (FDDG) Preparation

Corn distillers dried grains (DDGs) was obtained from a commercial fuel ethanol plant and was stored at −80° C. Food Grade DDG (or FDDG) was prepared using a procedure developed at South Dakota State University. The technique of FDDG production involved washing with food grade solvents, grinding, sterilizing and vacuum treatment.

DDGs was steeped with 200% proof ethanol (w/v, 1:1) in a stainless steel pot for hours, with constant stirring. The steeped DDGs was then sieved using a 0.125 mm mesh to remove the ethanol. DDGs was washed with 200% proof ethanol five times in succession. The washed DDGs was dried at room temperature for 3 days. The dried DDGs was milled with Restch Mill (GmbH & Co. KG, 5657 HAAN1, Germany) which was operated at 20,000 rpm using a 0.5 mm sieve. The final product, FDDG, was stored at 4° C. Sterilization was done in glass vessels in an autoclave at 15 psi for 15 minutes. One non-limiting example of the composition of the Food Grade DDG (FDDG) provided by the processes and methods of the invention is provided in Tables 1-3.

TABLE 1

| Proximate Constituent | Level (%, d.b.) |
|---|---|
| Protein | 39.3 |
| Fat | 9.53 |
| Ash | 1.55 |
| Carbohydrate (by difference) | 49.62 |
| Neutral Detergent Fiber | 38 |
| Total | 100.0 |
| Moisture (%, w.b.) | 1.70 |

TABLE 2

| Heavy Metal Element | Level (PPM) |
|---|---|
| Arsenic | <0.30 |
| Cadmium | <0.05 |
| Copper | 5.40 |
| Lead | <0.03 |
| Mercury | <0.10 |
| Selenium | 2.06 |

TABLE 3

| Mycotoxin | Level (PPM) |
|---|---|
| 15-Acetyl DON | 0.50 |
| 15-Acet-scirp | 0.50 |
| 3-Acetyl DON | 0.50 |
| Acetyl T-2 | 0.50 |
| Aflatoxin | 0.02 |
| DAS | 0.50 |
| FumonisonB1 | 5.00 |
| FusarenoneX | 0.50 |
| HT-2 Toxin | 0.50 |
| Iso-T-2 Toxin | 0.50 |
| Neosolaniol | 0.50 |
| Nivalenol | 0.50 |
| Scirpentriol | 0.50 |
| T-2 Tetraol | 1.00 |
| T-2 Toxin | 0.50 |
| T-2 Triol | 0.50 |
| Vomitoxin | 0.20 |
| Zearalenol | 0.50 |
| Zearalenone | 0.50 |

### Example 2

### Effect of Corn Distillers Dried Grains on Dough Properties and Qualities of Chinese Steamed Bread

Steamed bread is a traditional staple food in China. Steamed bread is commonly produced using wheat flour, a fermenting agent and water. Baked bread is often made from flour, salt, sugar, a leavening agent and fat. Like baked bread, steamed bread also has an elastic, chewy, spongy, and uniform texture, as well as smooth and shiny surface. Although there are similarities, there is an essential processing difference between steamed bread and bread. Baked bread is baked at 200° C., which results in a significant loss of lysine and vitamin B 1. Steamed bread is steamed at 100° C. This processing method for steamed bread does not produce any harmful substances and the nutrient loss is very small. In nutritional value, the protein valence of steamed bread is higher than that of baked bread. Therefore the energy contained in the steamed bread is significantly lower than that of bread at the same amount of flour. Although the processing method of steamed bread as far as possibly preserves the nutrient component, the nutritional value of steamed bread also has been decreased due to the fine processing technology of wheat flour. Many researchers have used okra, corn, rice bran and wheat bran to replace part of wheat flour in bread or steamed bread to improve nutritional value of products (Abdul-Hamid, 2000; Rose, 2010; Liu, 2012; Lu, 2013).

Qualities of steamed bread are mainly influenced by the ingredients of flour. DDGs contains high levels protein, dietary, fiber and pigments (Rosentrtaer and Krishnan 2010). The gluten in steamed bread comes from the wheat flour. Gluten network structure cannot be formed after adding water. Some studies reported the rheological, texture profile analysis and sensory properties of dough and steamed bread substituted with various dietary fiber. Fu (2015) suggested that the addition of lemon fiber increased the hardness of steamed bread and decreased cohesiveness, specific volume and elasticity. The substitution of 3%-6% lemon fiber can make the steamed bread healthy and acceptable. Wu (2014) investigated the effect of different amounts of pineapple peel fiber on rheological and textural properties of dough and steamed bread and suggested the steamed bread with 5-10% pineapple peel fiber is propitious to increase the intake of dietary fiber. Liu (2011) evaluated corn breads substituted with different percent of DDGs and indicated that the corn bread with 30 g/100 g DDGs reduce the textural quality. Tsen (1983) and Pourafshar (2014) and Pourafshar (2015) also used DDGs in bread and tortilla production. However, scant research has been done on steamed bread with DDGs. The results can be expected to provide a theoretical basis for the comprehensive utilization of FDDG and potential development of high fiber steamed bread production.

In this study, wheat flour was substituted for different percentages of FDDG in steamed bread. The rheological behavior of the flour, image analysis, texture profile analysis, and quality analysis of steamed bread were determined to evaluate the effects of FDDG on the qualities of steamed bread. The effect of DDG added to all purpose flours at the replacement levels of 0, 10, 15, 20 and 25 g per 100 g flours on the properties of dough and Chinese steamed bread was investigated using the procedures provided hereinbelow.

Corn distillers dried grains (DDGs) was obtained from a commercial fuel ethanol plant and was stored at −80° C. All purpose flour (APF) and dry yeast were purchased from commercial sources. Food Grade DDG (FDDG) was prepared from the DDGs using the processes and methods provided herein. Experimental concentrations of FDDG and APF were separately mixed for 1 hour with a twin-shelled (V-shaped mixing chamber) dry blender (Peterson Kelly Co. Inc, Stroudsburg, Pa.).

The moisture content of the blend was measured according to AACC Method 44-15. The ash content of the blend was determined by calcination at 550° C. (AACC Method 08-01). Protein analysis of the blend was done according to AACC Method 46-30 (% N×6.25). The fat content of the blend was measured according to AACC Method 30-25.01. Neutral detergent fiber (NDF) of the blend was determined according to AOAC Method 30-25. Color parameters of the blend were obtained by a Hunter Colorimeter (Hunter Associates Laboratory, Reston, Va.) using the Hunter L*, a*, and b* color scale. The parameters were triplicate readings at different positions of streamed bread, and mean value was recorded (Hunter Associates laboratory, 2002).

Steamed breads with FDDG were prepared according to the Chinese standard GB/T 17320-2013. The amount of water in blend flour was calculated by the water absorption from mixolab analysis. Dry yeast (2 g, 1%) was dissolved in water of the calculated amount (30° C.). The blends of APF and DDG (total amount: 200 g) were added to the bowl and mixed in a flour blender for 6 min until the gluten formed and the dough surface smoothed. The dough was sheeted by passing through 0.6 cm sheeter for 15-20 times. The dough sheet was rolled into a cylinder and divided into two pieces. The separated dough was rounded by hand to make the surface smooth. The round dough was placed in a steamer tray which lay with wet cheesecloth, and was proofed for approximately 40 min at 37° C. and 70%-80% RH. The proofed dough was steamed for 15 min in a stainless steel steamer.

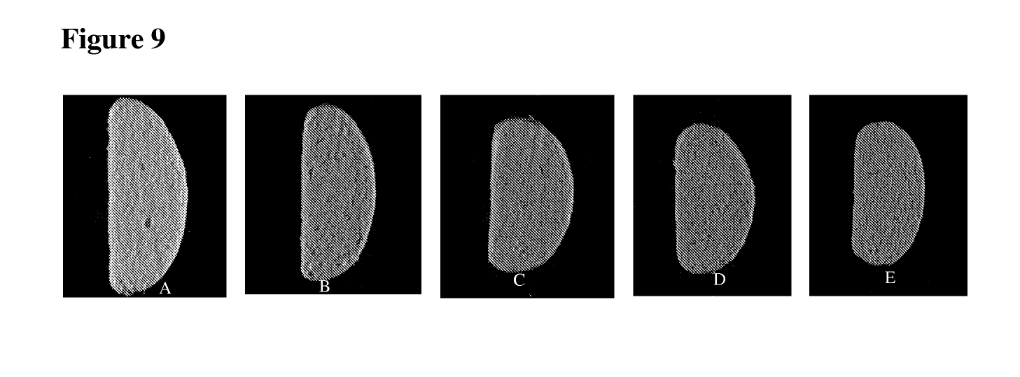

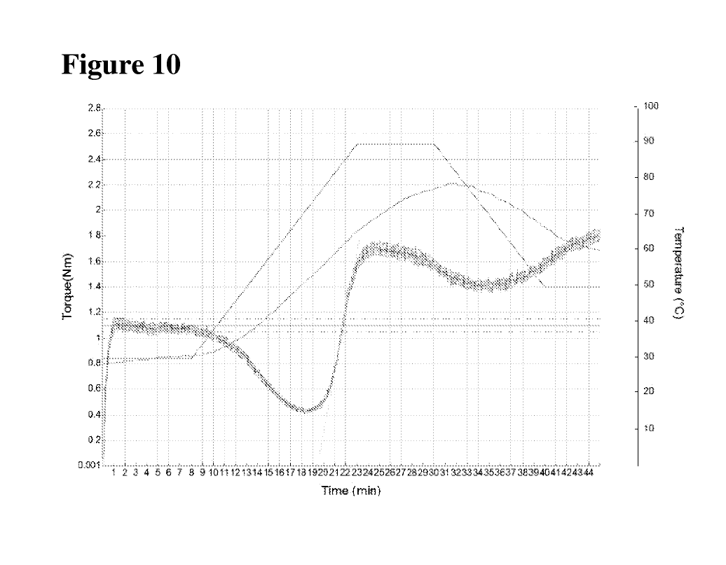

The rheological behavior of the dough was determined by Mixolab® (Chopin Technologies, Villeneuve La Garenne, France) according to “Chopin+” protocol. The standard procedure was followed: initial equilibrium at 30° C. for 8 min, heating to 90° C. at a rate of 4° C./min and holding at 90° C. for 7 min, cooling to 50° C. at a rate of 4° C. and holding at 50° C. for 5 min. The mixing speed was 80 rpm consistently. Parameters obtained from typical Mixolab curve (FIG. 9) were as follows: water absorption (%) or the amount of water required to produce a torque of 1.1 Nm; dough development time (min) or the time to reach the maximum torque (C1, Nm) at 30° C.; stability (min) or the time to hold the torque at 1.1 Nm; minimum torque (C2, Nm) or the minimum value of torque produced by dough passage subjected to mechanical or thermal constraints; peak torque (C3, Nm) or the maximum value of torque produced during the heating stage; the minimum value of torque during the heating period (C4, Nm); final torque (C5, Nm) or maximum value of torque obtained after cooling at 50° C. The slope of the curve between the end of constraint 30° C. and C2 (α) indicated the weakening rate of the protein network under the action of heating. The rate of gelatinization was showed by the slope of the curve between C2 and C3 (β). The slope of the curve between C3 and C4 (γ) indicated the rate of amylose retrogradation (Rosell et al., 2007; Ozturk et al., 2008; Koksel et al., 2009; Rosell et al., 2010; Hadnadev et al., 2011; Rosell et al., 2011; Jia et al., 2011; Chakraborty et al., 2015).

Dough extensibility and resistance to extension were determined by Texture analyzer (TA-XT2i, Stable Micro Systems, Surrey, UK). Texture analyzer was equipped with a Kieffer dough and gluten extensibility rig (A/KIE) with a 5 kg load cell and operated in tension mode. A dough ball of 10 g was placed onto the oiled grooved mold and pressed into strip dough. The strip dough was rested for 45 minutes to allow gluten network relaxation. The strip dough was clamped between the two plates of the Kieffer extensibility rig and the test was done immediately to avoid deformation of dough strip. The strip dough was stretched with a certain speed until its fracture. The measurement was conducted under the following settings: pre-test speed: 2.0 mm/s, test speed: 3.3 mm/s, post-test speed: 10.0 mm/s, distance: 75 mm, trigger force: auto—5 g, data acquisition rate: 200 pps (Fu, 2014; Wu, 2014; Heitmann, 2015).

Texture profile analysis (TPA) of steamed bread was measured by a texture analyzer (TX.XT-plus, Stable Micro Systems, Surrey, UK) equipped with a 5 kg load cell and a 25 mm diameter cylindrical probe (P/25). The TPA analysis of steamed bread was performed 24 h after steaming at room temperature. Steamed bread was sliced lengthwise in the middle to obtain uniform slices of 25 mm thickness. A sampler (120 mm) was used to get samples from the center of slices. Each sample was compressed twice with the following setting parameters: Pre-test speed 1 mm/s, test speed 1 mm/s, post-test speed 2 mm/s, compression strain 40%, trigger type, auto trigger force 5 g (Crowley, 2002; Miñarro, 2010; Lu, 2013). The quality scoring system was set up according to China standard GB/T 17320-2013 to test the qualities of the steamed bread with FDDG.

Image analysis of steamed bread was determined 24 h after steaming using a C-Cell Bread Imaging System and C-Cell Version 2 Software (Calibre Control International Ltd., UK). Steamed bread was sliced into 25 mm thickness in the middle. Parameters such as slice area, wrapper length, slice brightness, number of cells, cell diameter and wall thickness were obtained from captured image (Sroan, 2009; Alvarez-Jubete, 2010; O'Shea, 2015).

Steamed bread was reheated with boiling water for 6-8 minutes and cooled down for 3-5 minutes. The quality scoring system was set up according to China standard GB/T 17320-2013 (Table 4). Height of streamed bread was measured using vernier caliper and repeated two times from different sides. The volume of streamed bread was determined by rapeseed displacement according to AACC Method 10-05.01. Steamed bread was placed in disposable dish coded by random number. Samples were ordered by random permutation. The panel consisted of 12 trained judges (six males and six females). The panelists were required to rinse the mouth with lukewarm water between samples. Five samples with 10% DDG, 15% DDG, 20% DDG, and 25% DDG respectively, including a standard sample (0% DDG) were evaluated. Panelists were asked to assess the stream breads for acceptability of specific volume, height, surface color, surface structure, exterior appearance, interior structure, elasticity, chewiness, stickiness, and flavor.

TABLE 4
Quality scoring system for steamed bread with FDDG

| | Full | |
|---|---|---|
| Quality parameter | score | Scoring criteria |
| Specific volume | 15 | Specific volume ≧ 2.8 = 15; |
| (volume/weight, | | Specific volume ≦ 1.5 = 2; |
| mL/g) | | 2.8 ≦ Specific volume ≦ 1.5, minus 1 score per 0.1 mL/g |
| | | reduction |
| Height | 5 | Height ≧ 7cm = 5; |
| | | Height ≦ 5 cm = 1; |
| | | 5 cm ≦ Height ≦ 7cm, minus 1 score per 0.5 cm reduction |
| Surface color | 10 | White, milky white = 8~10; |
| | | Light yellow, yellow = 6~8; |
| Surface structure | 10 | Gloom = 2~6 |
| | | Smooth = 8~10; |
| Exterior appearance | 10 | Pliable, wavy, air bubble or concave = 3~8 |
| | | Symmetrical, spherical = 7~10; |
| | | Flat, unsymmetrical = 4~7 |
| Interior structure | 15 | Tiny pores, uniform = 12~15; |
| | | Close pores, uniform or separated between the edges |
| | | and the epidermis = 8~12; |
| | | Large pores, rough structure = 5~11; |
| Elasticity | 10 | Rebound quickly, can be compressed more than 1/2 = 7~10 |
| | | Rebound slowly or does not rebound = 3~7; |
| | | Difficult to compress, very hard = 2~6 |
| Chewiness | 10 | Chewy = 7~10; |
| | | Tender, crumble, low elasticity = 4~7 |
| Stickiness | 15 | Does not stick to teeth = 8~10; |
| | | Slightly sticky or sticky = 3~7 |
| Flavor | 5 | Wheat flavor, no peculiar flavor = 4~5; |
| | | Bland flavor = 3~4; |
| | | Peculiar flavor = 1~3 |
| Total score | 100 | — |

All data were determined in triplicate and expressed as mean±standard deviation. A one-way analysis of variance (ANOVA) and Duncan's multiple range tests were used to analyze significant difference of means at p<0.05. Statistical analyses were performed using SPSS software.

TABLE 5
Physicochemical properties of food grade DDG and all-purpose flour

| | Moisture | Color | | |
|---|---|---|---|---|
| Flour Type | (%) | L* | a* | b* |
| FDDG | 6.85 | 86.45 | −0.31 | 19.72 |
| APF | 11.80 | 91.43 | 0.13 | 8.14 |

^{a} NDF: Neutral Detergent Fiber;
APF: All-purpose flour

TABLE 6
Color of blends and steamed bread

| | Blend Color | | | Steamed bread Color | | |
|---|---|---|---|---|---|---|
| | L* | a* | b* | L* | a* | b* |
| 0% | 91.43 ± 0.20a | 0.13 ± 0.01a | 8.14 ± 0.13e | 76.83 ± 0.17a | −0.62 ± 0.07e | 13.54 ± 0.12c |
| FDDG | | | | | | |
| 10% | 90.06 ± 0.11b | −0.16 ± 0.04b | 11.91 ± 0.11d | 72.50 ± 0.15b | −0.05 ± 0.02d | 19.15 ± 0.16c |
| FDDG | | | | | | |
| 15% | 89.87 ± 0.06b | −0.26 ± 0.02c | 12.92 ± 0.20c | 69.62 ± 0.15c | 0.36 ± 0.01c | 19.83 ± 0.35b |
| FDDG | | | | | | |
| 20% | 89.39 ± 0.08c | −0.31 ± 0.07c | 13.97 ± 0.22b | 67.60 ± 0.20d | 0.64 ± 0.03b | 20.27 ± 0.31a |
| FDDG | | | | | | |
| 25% | 89.21 ± 0.11c | −0.29 ± 0.03c | 14.29 ± 0.13a | 66.62 ± 0.01e | 0.94 ± 0.04a | 20.49 ± 0.11a |
| FDDG | | | | | | |

Mean ± standard deviation values in the same column that are followed by the different letters are significantly different (p < 0.05).

Physicochemical properties of food grade DDG (FDDG) and all purpose flour were shown in Table 5. The ash content of FDDG was higher than that of APF; result from the higher fibre content in FDDG. Color is represented with L*a*b* values, L*=0 for the darkest black, and L*=100 for the brightest white. The red/green opponent colors are represented green at negative a* values and red at positive a* values. The yellow/blue opponent colors are represented blue at negative b* values and yellow at positive b* values (Te Yeh, 2009; Wikipedia). As can be seen from Table 5, FDDG was much darker than APF, and more yellow and green value than that of APF.

From Table 6 it can be observed that the protein, fibre and ash content of steamed bread increased with the increasing amount of FDDG. Protein content and quality are the main factors that affect the quality of steamed bread. High glutenin content is beneficial to increase the height and specific volume of steamed bread.

The additions of FDDG decreased the brightness (L*) of blends and steamed bread. With the increasing amount of FDDG the yellowness (b*) of blends and steamed bread increased due to the pigments of corn. The redness (a*) values were different between blends and steamed bread. The blends with FDDG were represented as negative a* values, which tend to green color. On the contrary, the increase of FDDG substitution resulted in positive a* values which showed a tendency to red color. Liu (2011) reported that DDGs in corn bread induce a decrease in brightness (L*) and yellowness (b*), as well as an increase in redness (a*). Rasco (1987) demonstrated that the blends and breads with DDGs were darker, redder, and more yellow than control groups. These results were consistent with Tsen (1983), Liu (2011), Singh (2012) and Pourafshar (2014).

TABLE 7
Effect of DDG on Mixolab Parameters of dough

| Samples | 0% DDG | 10% DDG | 15% DDG | 20% DDG | 25% DDG |
|---|---|---|---|---|---|
| Water | 53.50 ± 1.00e | 62.03 ± 0.45d | 64.63 ± 0.40c | 68.33 ± 0.06b | 71.40 ± 0.53a |
| Absorption | | | | | |
| (%) | | | | | |
| Development | 1.45 ± 0.10a | 1.18 ± 0.31ab | 1.18 ± 0.06ab | 1.13 ± 0.05b | 1.03 ± 0.07b |
| Time(min) | | | | | |
| Stability (min) | 9.80 ± 0.70a | 9.58 ± 0.37a | 8.38 ± 1.26ab | 7.50 ± 1.58b | 9.38 ± 0.65ab |
| C2(Nm) | 0.42 ± 0.03a | 0.41 ± 0.03a | 0.39 ± 0.02a | 0.40 ± 0.03a | 0.41 ± 0.05a |
| C3(Nm) | 1.59 ± 0.18a | 1.50 ± 0.04ab | 1.36 ± 0.08ab | 1.37 ± 0.07ab | 1.20 ± 0.33b |
| C4(Nm) | 1.23 ± 0.18a | 0.89 ± 0.01b | 0.73 ± 0.02bc | 0.62 ± 0.02cd | 0.50 ± 0.11d |
| C5(Nm) | 1.62 ± 0.25a | 1.24 ± 0.01b | 1.00 ± 0.07c | 0.84 ± 0.06dc | 0.75 ± 0.09d |

Mean ± standard deviation values in the same column that are followed by the different letters are significantly different (p < 0.05).

TABLE 8
Effect of FDDG on the resistance to extension and extensibility of dough

| | Resistance to Extension | Extensibility |
|---|---|---|
| Samples | g | mm |
| 0%FDDG | 33.42 ± 1.10e | 21.96 ± 0.99e |
| 10%FDDG | 43.31 ± 0.54d | 16.59 ± 0.25d |
| 15%FDDG | 51.52 ± 0.23c | 14.39 ± 0.46c |
| 20%FDDG | 57.23 ± 0.22b | 12.08 ± 0.28b |
| 25%FDDG | 68.13 ± 0.96a | 10.42 ± 0.39a |

Mean ± standard deviation values in the same column that are followed by the different letters are significantly different (p < 0.05).

TABLE 9
Effect of DDG on textural parameters of steamed bread

| | Hardness | Adhesiveness | | | Chewiness | |
|---|---|---|---|---|---|---|
| Samples | g | g · s | Cohesiveness | Springiness | g | Resilience |
| 0% FDDG | 450.02 ± 34.76e | 0.52 ± 0.06b | 0.67 ± 0.01a | 0.90 ± 0.00a | 274.58 ± 23.35c | 0.30 ± 0.00a |
| 10% FDDG | 1235.90 ± 64.89d | 7.39 ± 0.51b | 0.61 ± 0.01b | 0.81 ± 0.02b | 608.02 ± 38.45b | 0.26 ± 0.01b |
| 15% FDDG | 2289.96 ± 24.33c | 28.16 ± 15.24b | 0.54 ± 0.00c | 0.74 ± 0.00c | 918.78 ± 13.44a | 0.23 ± 0.00c |
| 20% FDDG | 2527.48 ± 62.04b | 38.91 ± 17.19ab | 0.53 ± 0.01c | 0.70 ± 0.05c | 938.71 ± 45.98a | 0.22 ± 0.01c |
| 25% FDDG | 3075.60 ± 68.30a | 75.70 ± 48.93a | 0.50 ± 0.02d | 0.57 ± 0.01d | 879.50 ± 48.70a | 0.20 ± 0.01d |

Mean ± standard deviation values in the same column that are followed by the same letters are not significantly different (p > 0.05).

Mixolab Parameters of dough with different amounts of FDDG were shown in Table 7. With the increasing amount of FDDG the water absorption of the dough increased significantly from 53.50% (0% DDG) to 71.40% (25% DDG). This was mainly because many hydrophilic groups of dietary fiber in FDDG can be combined with more water molecule through hydrogen bonding (Rosell, 2001). Sudha (2007) pointed out that wheat flour-bran blends with higher content of dietary fiber increased water absorption from 60.3% to 76.3%. Wang (2002) also found that highest absorption was produced with the addition of pea fibre. A similar effect was also observed by Jia (2011) and Boj\check{n}anská (2014). Higher water absorption can improve the water holding capacity of bread, which is favorable to the fresh-keeping of the product.

The addition of FDDG had negative effects on development time and stability of the dough. The development time of 0% FDDG was 1.45 min which was significantly higher than that of 25% FDDG. With the increasing amount of FDDG the dough stability decreased, but the stability of 25% FDDG increased compared to 15% FDDG and 20% FDDG. The development time and stability reflect the strength of the protein network structure in the process of dough mixing (Rosell et al, 2010; Boj\check{n}anská et al, 2014). Downward trend of development time and stability indicated the addition of FDDG weakened the gluten strength, decreased stirring endurance, resulted in being difficult to form the continuous gluten network. The increased stability of 25% FDDG may be due to higher content of fiber caused rigidity in the dough. Hadnadev (2011) indicated that the wholegrain wheat flour with higher content of seed coat has lower stability. But Boj\check{n}anská et al. (2014) described that with increasing addition of potato fibre, the dough development time increased. Wang (2002) also demonstrated that carob fibre did not modify the development time or the stability. These contradictory results may be due to different composition of dietary fiber and interactions between fibers and gluten. Tsen (1983) reported that the substitution of DDG in white flour increased water absorption, meanwhile decreased the development time and stability time. Similar results from corn pericarp dietary fiber were obtained by Wu (2014).

There was no significant difference (p>0.05) of C2 between 0%-25% FDDG, which indicated the mechanical or thermal constrains of protein was not improved by the addition of FDDG. The increasing amount of FDDG resulted in a decrease of C3. It was evident that FDDG has a negative influence on heat resistance of protein of the dough. The decreasing trend of C4 and C5 which parameters related to starch retrogradation showed DDG have a certain inhibitory effect on starch retrogradation. This may be due to the decrease starch content and the increased fiber content of FDDG. Dietary fiber of FDDG is heated to form a gel, which hinders the recovery of hydrogen bond between the straight chain starch molecules and reduces starch retrogradation rate. Rosell (2010) showed that the addition of sugar beet fiber and pea hull fiber led to decrease of C3, C4, and C5. Hadnadev (2011) demonstrated that wholegrain flour has worse performance of C3, C4, and C5. Torbica (2010) indicated that the increasing the amount of husked buckwheat flour and unhusked buckwheat flour (UBF) decreased the C3 value.

Table 8 shows the addition of FDDG has a large impact on the dough extensibility. The extensibility of dough with 0% FDDG significantly higher than that of 25% FDDG, which illustrates that the addition of FDDG made the dough easily fractured. With the increasing addition of FDDG, the resistance to extension values of dough significantly increased. The resistance to extension of dough reflects the strength and flexibility of dough. The greater the resistance is, and the stiffer the dough. The addition of FDDG reduced the relative content of gluten in wheat flour, which affected the formation and stability of the dough, and decreased the extensibility of the dough. Sudha (2007) and Fu (2014) also pointed out that DDG is rich in rigid dietary fiber which hinders the formation of the gluten network, resulting in the decreased extensibility and the increased stiff of the dough. Wu (2014) reported that the addition of pineapple peel fiber resulted in stiffer and less extensible dough. Fu (2015) indicated that lemon fiber had a highly negative extensibility of dough.

Textural parameters of steamed bread were shown in Table 9. With the addition of FDDG, the hardness of streamed bread increased significantly from 450.02 g to 3075.60 g (p<0.05). At the same time, the cohesiveness, the springiness, resilience of streamed bread decreased. This was mainly due to the gluten content decreased with increasing amount of FDDG. The formation of consecutive three-dimensional network structure in the dough was restrained, resulting in the reduction of the gas cells in the steamed bread, which lead to the increase of steamed bread hardness, and the decrease of cohesiveness, springiness, and resilience (Amir, 2013; Gomez, 2013). Cohesiveness reflects the strength of binding force of steamed bread. The steamed bread with weakened cohesiveness is easy to form crumble. Therefore, with the increase of FDDG amount, the quality of steamed bread decreased. Frutos (2008) suggested that the moisture is correlated negatively with cohesiveness and positively with hardness. The mixolab results indicated FDDG-enriched steamed bread has higher water absorption and strength of water holding capacity. This is another reason for the changing trend of cohesiveness and hardness. An increase in adhesiveness was also observed with the addition of DDG result from the higher moisture content of steamed bread. As FDDG amount increased from 0% to 20%, the chewiness of steamed bread increased from 274.58 g to 938.71 g. But the chewiness of steamed bread decreased when the FDDG amount reached to 25%. This was mainly because the steamed bread with higher hardness and lower cohesiveness and crumbled easily. Amir (2013) pointed out that the hardness of high fiber bread increased significantly by adding 10% to 20% cocoa pod husk powder. Lu (2013) also demonstrated that adhesiveness increased with the addition of fiber-enriched okara steamed bread and springiness, cohesiveness and resilience reduced. Wang (2002) indicated that inulin addition increased the firmness and chewiness of crumb. The same trend of steamed bread with pineapple peel fiber was observed by Wu (2014). Frutos (2008) reported that the resilience wheat bread with artichoke fiber was significantly lower than control breads. Feili (2013) also described the high fiber bread incorporated with jackfruit rind flour showed significantly higher values of chewiness (p<0.05).

Similar effects were also observed by Wu (2012) Fu (2014), Chang (2015), and Fu (2015).

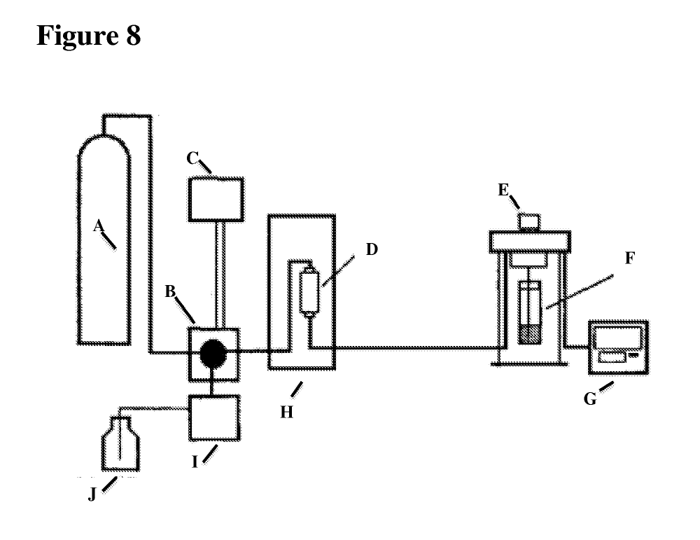

The image analyses of steamed bread with different percents of FDDG are shown in Table 10. The C-Cell images of steamed bread are presented in FIG. 8. The wrapper length of steamed bread was significantly decreased with the addition of FDDG. A decrease in the slice area of steamed bread was also observed in Table 10 and FIG. 8. This indicated that the addition of FDDG made the structure of steamed bread became more compact. Number of cells of steamed bread decreased significantly between 0% FDDG and 25% FDDG, but there is no significantly difference between 10% FDDG to 20% FDDG. Cell diameter and wall thickness exhibited wave change trend. The number of cells and wall thickness are good measure parameters for the proofing quality ((Purna, 2011; O'Shea, 2015). A good steamed bread structure should have a higher number of cells and lower values of wall thickness and cell diameter. The steamed bread with higher substitution of FDDG produced less gas (carbon dioxide) result from the decreased fermentation of starch. The decreasing protein network structure retained less gas result in the decrease of number of cells. The wall thickness is performed for exquisite degree, the thinner of wall thickness, the more exquisite texture. The wall thickness was not significantly different among 0% FDDG-20% FDDG. This indicated the addition of FDDG (lower than 20%) has a little effect on the exquisite degree of steamed bread. With the increase amount of FDDG, slice brightness of steamed bread was decreased significantly (p<0.05) from 131.13 to 79.27. Brightness is the average gray value of the pixels in the slice. The samples with dim color had low brightness value. Large or deep hole of the samples also cause a large shadow and lower brightness value. This change is mainly due to the corn yellow pigment and the larger hole in the slice with the increasing amount of FDDG.

Mäkinen (2012) reported that higher levels of barley and oat decreased number of cells and increased the wall thickness which deteriorating the quality of bread. Ktenioudaki (2013) reported that samples with brewer's spent grain have a smaller number of cells of larger diameter than the control sample. In the study of health white breads with barley middlings, wholegrain and pearled barley decreased the number of cells and area of cells (Sullivan, 2011).

TABLE 10
Image analysis of steamed bread with different percents of FDDG

| Samples | 0% FDDG | 10% FDDG | 15% FDDG | 20% FDDG | 25% FDDG |
|---|---|---|---|---|---|
| Slice Area | 4763.67 ± 68.19a | 3810.67 ± 52.27b | 3724.00 ± 78.26bc | 3642.00 ± 137.01c | 3403.33 ± 66.08d |
| (mm²) | | | | | |
| Wrapper | 280.50 ± 1.41a | 247.93 ± 7.31b | 238.90 ± 0.78c | 230.90 ± 3.74d | 221.03 ± 1.42e |
| Length | | | | | |
| (mm) | | | | | |
| Number of | 4144.33 ± 204.18a | 3347.00 ± 323.11b | 3388.00 ± 237.31b | 3231.33 ± 91.27bc | 2886.33 ± 89.81c |
| Cells | | | | | |
| Cell | | | | | |
| Diameter | 1.69 ± 0.05ab | 1.71 ± 0.08ab | 1.56 ± 0.13b | 1.60 ± 0.08b | 1.84 ± 0.13a |
| (mm) | | | | | |
| Wall | | | | | |
| Thickness | 0.38 ± 0.02b | 0.40 ± 0.02ab | 0.39 ± 0.01ab | 0.40 ± 0.00ab | 0.42 ± 0.01a |
| (mm) | | | | | |
| Slice | 131.13 ± 0.21a | 96.47 ± 4.10b | 85.60 ± 1.23c | 81.23 ± 0.32cd | 79.27 ± 3.60d |
| Brightness | | | | | |

Mean ± standard deviation values in the same column that are followed by the same letters are not significantly different (p > 0.05)

TABLE 11
Quality analysis of steamed bread with DDG

| Quality parameter | | | | | |
|---|---|---|---|---|---|
| (score) | 0% DDG | 10% DDG | 15% DDG | 20% DDG | 25% DDG |
| Specific volume (15) | 14.75 ± 0.87a | 11.58 ± 1.24b | 8.75 ± 1.22c | 4.67 ± 0.65d | 3.08 ± 0.79e |
| Height (5) | 2.75 ± 0.62a | 2.50 ± 0.67ab | 2.50 ± 0.67ab | 2.17 ± 0.58bc | 1.67 ± 0.49c |
| Surface color (10) | 10.00 ± 0.00a | 7.75 ± 0.62b | 7.00 ± 0.95c | 6.08 ± 0.67d | 4.25 ± 01.36e |
| Surface structure (10) | 9.67 ± 0.49a | 9.00 ± 0.95ab | 8.00 ± 0.95bc | 7.83 ± 1.47c | 7.08 ± 1.83c |
| Exterior appearance (10) | 9.17 ± 1.40a | 8.50 ± 1.38ab | 7.92 ± 1.51ab | 8.33 ± 1.15ab | 7.33 ± 1.83b |
| Interior structure(15) | 13.67 ± 1.87a | 11.83 ± 3.10ab | 12.00 ± 2.59ab | 10.17 ± 2.72b | 10.58 ± 2.7 lb |
| Elasticity (10) | 9.75 ± 0.45a | 8.17 ± 1.59b | 7.33 ± 1.61bc | 6.42 ± 2.43c | 4.83 ± 2.21d |
| Chewiness (10) | 9.58 ± 0.67a | 8.00 ± 0.95b | 7.42 ± 1.44bc | 6.42 ± 1.38cd | 5.92 ± 1.88d |
| Stickiness (10) | 8.75 ± 1.60a | 7.33 ± 1.50b | 6.75 ± 1.76b | 6.08 ± 1.44bc | 4.75 ± 1.86c |
| Flavor (5) | 4.50 ± 0.90a | 4.33 ± 0.98a | 3.83 ± 0.72ab | 3.42 ± 0.79b | 3.33 ± 1.23b |
| Total score(100) | 92.58 ± 3.29a | 79.00 ± 5.20b | 71.50 ± 4.58c | 61.58 ± 6.24d | 52.83 ± 6.91e |

Mean ± standard deviation values in the same column that are followed by the same letters are not significantly different (p > 0.05). Less than 70 points is described as poor; 70 to 79 are general; 80 to 89 are good; greater than or equal to 90 are excellent.

The scores of quality analysis of steamed bread with FDDG are presented in Table 11. With the increase amount of FDDG, the specific volume score of steamed bread decreased significantly from 14.75 (0% FDDG) to 3.08 (25% FDDG). This may be related to dietary fiber of FDDG dilute the content of gluten resulting in the deterioration f gas retaining ability (Abbott et al., 1991; Inglett, 2005; Frutos, 2008). The specific volume reflects the volume expansion degree of the dough, the bigger specific volume is, and the higher bulkiness gets. The decrease of specific volume also has some influence on elasticity and chewiness. From Table 11 can be seen, the elasticity and chewiness score also decreased with higher amount of FDDG, as well as the height and stickiness score. Amir (2013) demonstrated that higher fiber content increased the water absorption capacity which causes a compact structure of loaf. The increase of moisture also increased the stickiness of steamed bread. The addition of FDDG had a significantly influence on the surface color. This is mainly due to the pigment of corn. The exterior appearance score is no significant different between 0% FDDG to 15% FDDG. The score of surface structure decreased with increasing amount of FDDG. The lacked air chamber gives rise to the wrinkle and collapse on the steamed bread surface. Because higher fiber content leads to rough structure, the interior structure score of steamed bread with 25% FDDG was lower than that of 0% FDDG. Flavor score decreased with increasing substitution of FDDG. Although the addition of FDDG made the bread with corn aroma, the higher amount of FDDG has a bitter taste which has a negative effect on the flavor of steamed bread. Good steamed bread should be chewy, slightly sticky, and good elasticity. From the total score can be seen, adding FDDG to steamed bread resulted in a decrease of the quality score. When the addition amount of FDDG is less than 15%, the quality score of steamed bread is more than 70, which indicate the quality of steamed bread is acceptable. But the quality score of steamed bread with 20% and 25% FDDG decreased significantly, indicating that the steamed bread with higher amount of FDDG has low specific volume, dark color, unsymmetrical appearance, crimpy surface, weak elasticity and poor quality of steamed bread. This quality changes was mainly as a result of the comprehensive changes of protein, dietary fiber, fat and ash of steamed bread. Therefore, steamed bread with 10-15% has little impact on the quality of steamed bread and increase fiber intake.

Almeida (2012) and O'Shea (2015) reported that the addition of dietary fibre reduced specific volume and crumb luminosity of bread significantly. Similar effects of maize fibre on specific volume were observed by Sabanis (2009). But Liu (2011) pointed out that the loaf volumes of breads increased with the addition of DDGS. The contradictory results could be due to different formulation of bread. Liu (2011) also demonstrated that the increase content of DDGS darkens bread appearance. Tsen (1983) found that the replacement at 20% DDG reduced the grain score. Fu (2014) and Feili (2013) also suggested that the bread with the highest dietary fiber decreased the overall acceptability.

The results showed that the addition of FDDG can lead to changes in dough properties and textural properties of dough and steamed bread. With the increasing amount of FDDG, the water absorption rate of dough increased, the extensibility of dough decreased; the volume of steamed bread with FDDG decreased; and the hardness of dough and steamed bread increased. The steamed bread with 20 g FDDG per 100 g flours was acceptable. Adding FDDG to the Chinese staple food-steamed bread can increase the nutritional value of steamed bread.

### Example 3

### Influence of the Extrusion Processing Parameters on the Physico-Chemical and Sensory Characteristics of Garbanzo Flour and Food Grade Distillers Grain Based Expanded Snacks

Extrusion of starch-based ingredients is an important technology used in the manufacturing of processed foods. While many of the starch-based ingredients are highly functional, there is need for ingredients that can deliver nutrients, fiber and health promoting food constituents. Pulse flours, when combined with distillers grains, represent a novel blend as they are gluten-free and high in protein and fiber content.

In this study, the effect of food grade distillers dried grains developed at South Dakota State University (FDDG: 1 to 10%) and extrusion process variables including barrel temperature (80-140° C.), screw speeds (80-140 rpm) and feed moisture content (14-20%) on the physicochemical properties (density, expansion, water absorption index-WAI, water solubility index-WSI) and sensory characteristics (hardness and crispness) of the garbanzo flour-based extruded snacks were investigated.

In this example, the extrusion process relates to the conditions of the extrusion, including but not limited to the rate of auger or screw rotation (RPM) and temperature of the heated barrel (in degrees centigrade). The extruder itself is made up of a hopper, a barrel, auger or screw, and a die. Other functional items may be included in the extruder, as desired. The rate of travel of the sample material is based on the rotation and pitch of the screw. As the sample travels through the heated barrel it undergoes constriction and enormous shear forces. Both physical shear and heat transform the starch and protein into a plastic-like material that is expelled through a die. The extruder can also be referred to as an “open ended pressure cooker”. Materials going through the extruder will puff when they reach the atmosphere.

In this study, high-protein puffed snacks were produced with unique blends of garbanzo flour (protein 22.42%, fiber 19%) and food grade distillers dried grains (FDDG; protein 36.8%, fiber 10.5%). An optimal design with three factor interactions (temperature, screw speed, and ratio of DDGs to corn starch) was developed. Blends were extruded in a single-screw extruder. Snacks were made by deep fat frying the extrudate in vegetable oil at 375° F.

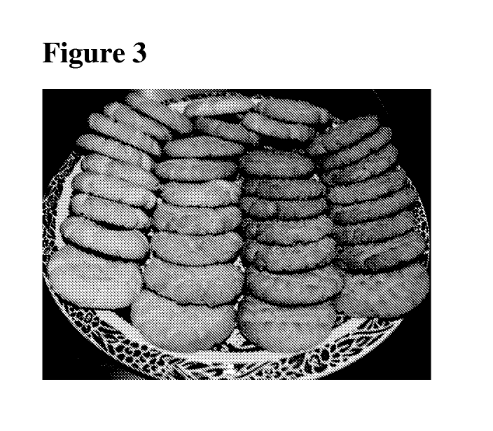

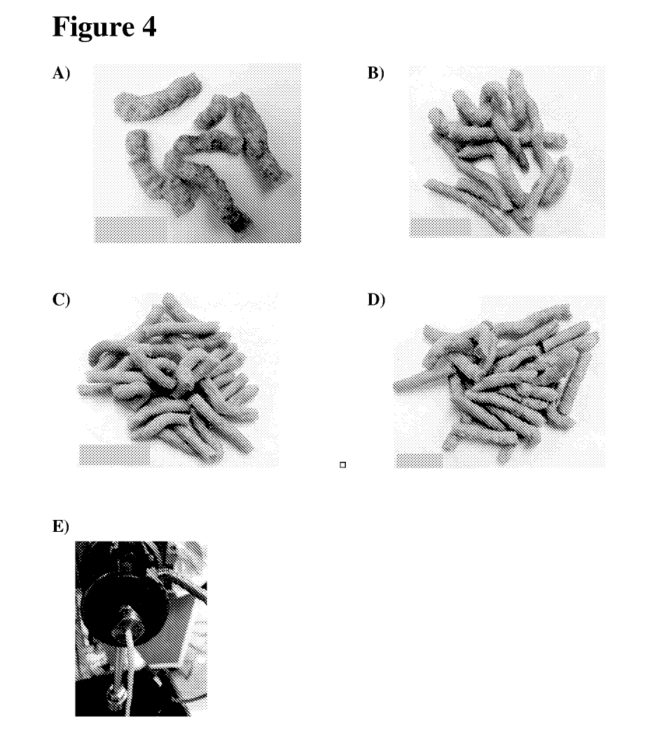

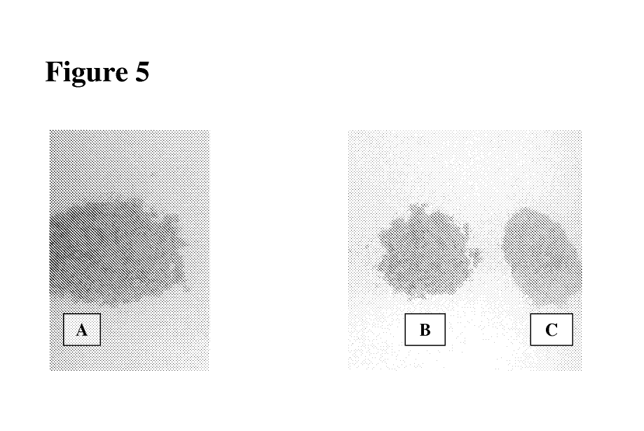

Incorporation of FDDG into garbanzo flour decreased torque and product expansion, but increased bulk density and hardness of extrudates (puffed products resulting from the extrusion). The barrel temperature had a significant effect (p<0.05) on the bulk density and hardness parameters. Optimum extrusion conditions resulting in minimum bulk density and maximum expansion ratio were estimated. The expanded products have good cell structure with varying cell sizes when viewed under a microscope. Expanded products with FDDG content 4-8%, 16% feed moisture extruded at barrel temperature 100-120° C. and screw speed of 80-100 rpm were chosen for sensory evaluation. See FIG. 3, Tables 12, 13 and 14.

Expanded snacks made with 5% FDDG were well accepted by taste panel. Sensory assessment of the extruded samples before and after frying in oil indicated that extrusion of garbanzo flour-FDDG blends can produce safe, palatable snacks for humans. These products may be used as tasty snacks having significantly improved protein and dietary fiber content.

TABLE 12
Amino acid content of pita bread fortified with food grade FDDG and
Chickpeas. Addition of FDDG and Chick pea flour increased amino
acids content significantly over control 100% wheat flat breads.

| Sample | Arginine | Histidine | Isoleucine | Leucine | Lysine | Methionine | Phenylalanine | Threonine | Valine |
|---|---|---|---|---|---|---|---|---|---|
| Control | .290 e | .180 e | .290 e | .540 e | .230 e | .130 e | .370 e | .220 d | .320 d |
| (wheat) | | | | | | | | | |
| 80% w- | .400 d | .220 d | .340 d | .650 d | .310 d | .150 d | .450 d | .280 c | .390 c |
| 20% g | | | | | | | | | |
| 80% w- | .420 c | .280 b | .410 b | 1.01 a | .340 c | .200 a | .530 b | .370 a | .500 a |
| 20% d | | | | | | | | | |
| 70% w- | .450 b | .250 c | .390 c | .850 c | .370 b | .170 c | .500 c | .330 b | .450 b |
| 20% g- | | | | | | | | | |
| 10% d | | | | | | | | | |
| 70% w- | .550 a | .290 a | .430 a | .920 b | .440 a | .180 b | .570 a | .370 a | .500 a |
| 20% d- | | | | | | | | | |
| 10% g | | | | | | | | | |

w: wheat flour
d: food grade FDDG
g: garbanzo flour (chickpea flour)

TABLE 13
Proximate Composition (%), Stability and Brightness of
FDDG and Pita made with Wheat:FDDG:Garbanzo blends

| mean | Protein | fat | Aw | L* |
|---|---|---|---|---|
| Pure | 23.3 b | 1.97 g | 0.3696 f | 90.1000 b |
| Garbanzo | | | | |
| (G) | | | | |
| Pure FDDG | 30.2 a | 10.24 a | 0.0810 g | 73.3233 f |
| (D) | | | | |
| Treatment | 11.4 g | 4.03 e | 0.5720 a | 90.7333 a |
| 1 | | | | |
| (100% APF) | | | | |
| Control | | | | |
| Treatment | 15.2d | 5.24 b | 0.4596 d | 84.2900 d |
| 2 | | | | |
| (80% W- | | | | |
| 20% D) | | | | |
| Treatment | 16.7 c | 4.37 c | 0.4140 e | 83.4833 e |
| 3 | | | | |
| (70% W- | | | | |
| 20% D- | | | | |
| 10% G) | | | | |
| Treatment | 11.8 f | 2.58 f | 0.5266 b | 90.4367 ab |
| 4 | | | | |
| (80% W- | | | | |
| 20% G) | | | | |
| Treatment | 14.9 e | 4.07d | 0.4800 c | 86.2033 c |
| 5 | | | | |
| (70% W- | | | | |
| 20% G- | | | | |
| 10% D) | | | | |

TABLE 14
Particle size distribution of all purpose flour (APF) and
FDDG washed with different solvents. Aqueous treatment
contributed to particle swelling and a shift in size distribution.

| | | | FDDG: | FDDG: | |
|---|---|---|---|---|---|
| | | | Aqueous/ | Aqueous/ | FDDG: |
| | | FDDG: | alcohol | alcohol | Ethanol |
| | APF | Original | Tmt | Tmt | Wash |
| Mesh Size | (%) | (%) | (%) | (%) | only |
| Above 40 | 0.00 | 1.95 | 2.08 | 2.00 | 0.96 |
| 40 | 4.96 | 44.65 | 64.09 | 63.67 | 8.09 |
| 400 μm | | | | | |
| 0.0165″ | | | | | |
| 60 | 41.40 | 51.12 | 28.88 | 31.21 | 24.47 |
| 250 μm | | | | | |
| 0.0098″ | | | | | |
| 80 | 39.86 | 0.90 | 2.75 | 2.28 | 43.27 |
| 180 μm | | | | | |
| 0.007″ | | | | | |
| 100 | 5.68 | 0.18 | 0.41 | 0.40 | 14.14 |
| 150 μm | | | | | |
| 0.0059″ | | | | | |
| 200 | 5.78 | 0.04 | 0.15 | 0.24 | 6.63 |
| 75 μm | | | | | |
| 0.0029″ | | | | | |

### Example 4

### Supercritical Carbon Dioxide Processing of Corn Distillers Dried Grain with Solubles

Supercritical carbon dioxide (SCO₂) is an ideal alternate solvent that can be used to upgrade FDDG to food-grade flour. Its high diffusion coefficients and dissolving power makes it suitable for the selective extraction of fatty acids and carotenoids. Carotenoids impart color while fatty acids produce an off-odor and off-flavor and their removal from FDDG will improve the baking functionality and customer acceptability.

Supercritical CO₂ extraction can be carried out using known systems and apparatuses. In this experiment, Supercritical CO₂ extraction was carried out using an apparatus as illustrated in FIG. 6A or 6B.

Ethanol washing of DDGs has been shown to improve the color of FDDG, but the use of SCO₂ gave similar or superior results with less processing time.

In this example, DDGs was processed using SCO₂ extraction as an optional extra solvent extraction, in order to determine if optional SCO₂ extraction has an effect on product brightness. In the SCO₂ extraction process, the experimental conditions were between 5000 psi and 15,000 psi, and 50° C., pressure and heat, respectively. The FDDG produced by the process that included the ethanol solvent treatment, SCO₂ extraction and the water washing had a significant reduction in pigments, as the yellowness and redness coloration were much lower than those of FDDG produced without the SCO₂ extraction. FDDG is light in color as compared to DDGs, however, the key difference is the low levels of coloration as determined from yellowness/redness measurements. Adding the optional step of SCO₂ extraction to the FDDG process showed minimal change in both lightness and yellowness/redness values. It is possible that this phenomenon can be attributable to the lack of solubles in the starting material (FDDG). Its ability to extract more pigments from FDDG shows its potential value as an optional step to the FDDG process. This may be due to a difference in the mechanism by which SCO₂ and ethanol washing affect FDDG. Ethanol is polar while carbon dioxide is non-polar, and the differences in polarity will confer difference in selectivity for solutes.

These terms, specifications, and embodiments, including the examples, serve to describe the invention by example and not to limit the invention. It is expected that others will perceive differences, which, while differing from the forgoing, do not depart from the scope of the invention herein described and claimed. In particular, any of the function elements described herein may be replaced by any other known element having an equivalent function.

All publications, patents, and patent documents are incorporated by reference herein, as though individually incorporated by reference.

What is claimed is:

1. A process for preparing a food grade distillers dried grain (FDDG) product, comprising,
a) steeping an amount of distillers dried grains (DDG) or distillers dried grains with solubles (DDGs) with an amount of a food grade first solvent to create a slurry, wherein the weight to volume ratio of solids to solvent is 1:1,
b) stirring the slurry continuously for an amount of time;
c) removing the first solvent from the solids;
d) adding second amount of the first solvent to the solids create a slurry, wherein the weight to volume ratio of solids to solvent is 1:1, and stirring the slurry continuously for an amount of time;
e) removing the first solvent from the solids;
f) repeating steps d) and e) one or more times;
g) washing the solids with an amount of a food grade second solvent for an amount of time;
h) removing the second solvent from the solids;
i) repeating steps g) and h) one or more times;
j) drying the solids to remove the second solvent; and
k) milling the washed, dried solids to a uniform size, wherein the result is a food grade distillers dried grain (FDDG) product.

2. The process of claim 1, wherein the first solvent is selected based on polarity of the solvent, solubility of target pigments, or solubility of flavor compounds to remove, or a combination thereof.

3. The process of claim 1, wherein the first solvent is ethanol or Supercritical CO₂.

4. The process of claim 1, wherein the second solvent is water.

5. The process of claim 1, where in the drying is freeze drying or lyophilizing.

6. The process of claim 1, further comprising sterilizing the milled FDDG product by heat treatment, pressure treatment, or a combination thereof.

7. The process of claim 6, further comprising sterilizing the FDDG product after milling by heating the FDDG product to about 120 C for 5 to 30 minutes, with steam injections and agitation.

8. The process of claim 1, wherein the milling is ultra-grinding, and the FDDG product has a particle size of about <1.0 mm.

9. The process of claim 1, wherein following f), the solids are optionally extracted using Supercritical CO₂ extraction.

10. The process of claim 1, further comprising recovering at least a portion of the first solvent, the second solvent or both solvents.

11. The process of claim 10, wherein pigments and oil are extracted from said recovered solvents.

12. The process of claim 1, wherein the DDG or DDGs is derived from any plant material.

13. The process of claim 12, wherein the DDG or DDGs is derived from corn.

14. The process of claim 1, wherein the process is completed in one or more vessels.

15. The food grade distillers dried grain product produced by the process of claim 1.

16. A food grade distillers dried grain product, comprising a solvent-treated plant-derived material having reduced pigmentation as compared to the plant derived material not treated with solvents, wherein the product has uniform particle size, is odor-neutral, and is at least 25% protein, at least 30% dietary fiber and less than 15% fat.

17. The food grade distillers dried grain product of claim 16, wherein the protein content is at least 30% protein and the dietary fiber content is at least 35%, and less than 10% fat.

18. The food grade distillers dried grain product of claim 16, wherein the particle size is <0.6 mm.
